(19) United States
(12) Patent Application Publication
(10) Pub. No.: US 2016/0082607 A1
(43) Pub. Date: Mar. 24, 2016

(54) ROTARY ELECTRIC SHAVER

(71) Applicant: IZUMI PRODUCTS COMPANY, Matsumoto-shi (JP)

(72) Inventor: Tetsuhiko SHIMIZU, Matsumoto-shi (JP)

(73) Assignee: IZUMI PRODUCTS COMPANY, Matsumoto-shi (JP)

(21) Appl. No.: 14/801,930

(22) Filed: Jul. 17, 2015

(30) Foreign Application Priority Data
Sep. 18, 2014 (JP) 2014-190461

(51) Int. Cl. B26B 19/14

(52) U.S. Cl. CPC B26B 19/143

(57) ABSTRACT

There is provided a rotary electric shaver whose outer blade can smoothly move along skin, which can reliably catch any type of hair, and which can prevent the skin from being damaged due to deep shaving.

A rotary electric shaver includes an outer blade whose upper surface functions as annular shaving surfaces having multiple hair inlets formed therein and an inner blade that has a small blade which rotates while coming into sliding contact with a lower surface of the outer blade from below the annular shaving surfaces. The outer blade is configured so that the hair inlets are juxtaposed by changing the circumferential distance in a predetermined circumferential area on the annular shaving surfaces.

### CROSS-REFERENCE TO RELATED APPLICATION

This application is based upon and claims the benefit of priority of the prior Japanese Patent Application No. P2014-190461, filed on Sep. 18, 2014, and the entire contents of which are incorporated herein by reference.

### FIELD

The present invention relates to a rotary electric shaver.

### BACKGROUND

For example, a rotary electric shaver is known which cuts hair entering multiple hair inlets while including an outer blade whose upper surface functions as an annular shaving surface having the multiple hair inlets formed therein and an inner blade that has a small blade which rotates while coming into sliding contact with a lower surface of the outer blade from below of the annular shaving surface (refer to PTL 1).

### CITATION LIST

### Patent Literature

PTL 1: JP-T-2006-510430

### SUMMARY

### Technical Problem

In the related art, a rotary electric shaver particularly has the following important issues: (a) whether an outer blade can smoothly move while following delicate and uneven portions of skin; (b) whether hair can be reliably caught corresponding to different hair characteristics of each user and can be prevented from being unshaved; and (c) whether skin can be prevented from being damaged due to deep shaving when an outer blade is strongly pressed against skin.

For example, according to a configuration of disposing a ridge in a partial area on an outer blade shaving surface in the circumferential direction as in the rotary electric shaver disclosed in PTL 1, it is possible to protect skin by reducing contact pressure applied to skin. On the other hand, there may be a problem of poor shaving performance in such a case. As described above, it is relatively easy to respectively and independently solve the above-described issues (a) to (c). However, when all of the issues are intended to be solved at the same time, various factors included therein conflict with each other. Consequently, a further advanced technique is required.

The present invention is made in view of the above-described circumstances, and an object thereof is to provide a rotary electric shaver whose outer blade can smoothly move along skin, which can reliably catch any type of hair, and which can prevent the skin from being damaged due to deep shaving.

### Solution to Problem

The object may be realized by providing embodiments disclosed hereinafter.

A rotary electric shaver disclosed includes an outer blade whose upper surface functions as annular shaving surfaces having multiple hair inlets formed therein; and an inner blade that has a small blade which rotates while coming into sliding contact with a lower surface of the outer blade from below the annular shaving surfaces, in which the outer blade is configured so that the hair inlets are juxtaposed by changing a circumferential distance in a predetermined circumferential area on the annular shaving surfaces.

### Advantageous Effects

According to the rotary electric shaver disclosed herein, an outer blade can smoothly move along skin, it is possible to reliably catch any type of hair, and it is possible to prevent the skin from being damaged due to deep shaving.

### BRIEF DESCRIPTION OF THE DRAWINGS

FIG. 1 is a schematic view (perspective view) illustrating an example of a rotary electric shaver according to an embodiment of the present invention.

FIG. 2 is a schematic view (exploded perspective view) illustrating an example of a head unit in the rotary electric shaver illustrated in FIG. 1.

FIG. 3 is a schematic view (perspective view) illustrating an example of an inner blade in the rotary electric shaver illustrated in FIG. 1.

FIG. 4 is a schematic view illustrating a small blade of the inner blade and a portion of an outer blade in the rotary electric shaver illustrated in FIG. 1.

FIG. 5 is a schematic view (plan view) illustrating a first embodiment of the outer blade in the rotary electric shaver illustrated in FIG. 1.

FIG. 6 is a sectional view of the outer blade illustrated in FIG. 5.

FIG. 7 is a schematic view (plan view) illustrating a second embodiment of the outer blade in the rotary electric shaver illustrated in FIG. 1.

FIG. 8 is a schematic view (plan view) illustrating a third embodiment of the outer blade in the rotary electric shaver illustrated in FIG. 1.

FIG. 9 is a schematic view (plan view) illustrating a fourth embodiment of the outer blade in the rotary electric shaver illustrated in FIG. 1.

FIG. 10 is a schematic view (plan view) illustrating a fifth embodiment of the outer blade in the rotary electric shaver illustrated in FIG. 1.

### DESCRIPTION OF THE EMBODIMENTS

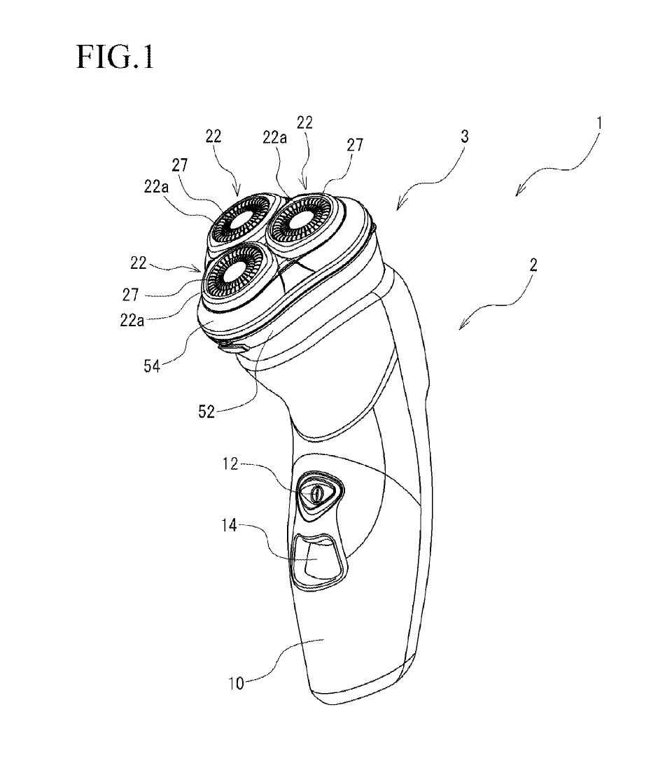

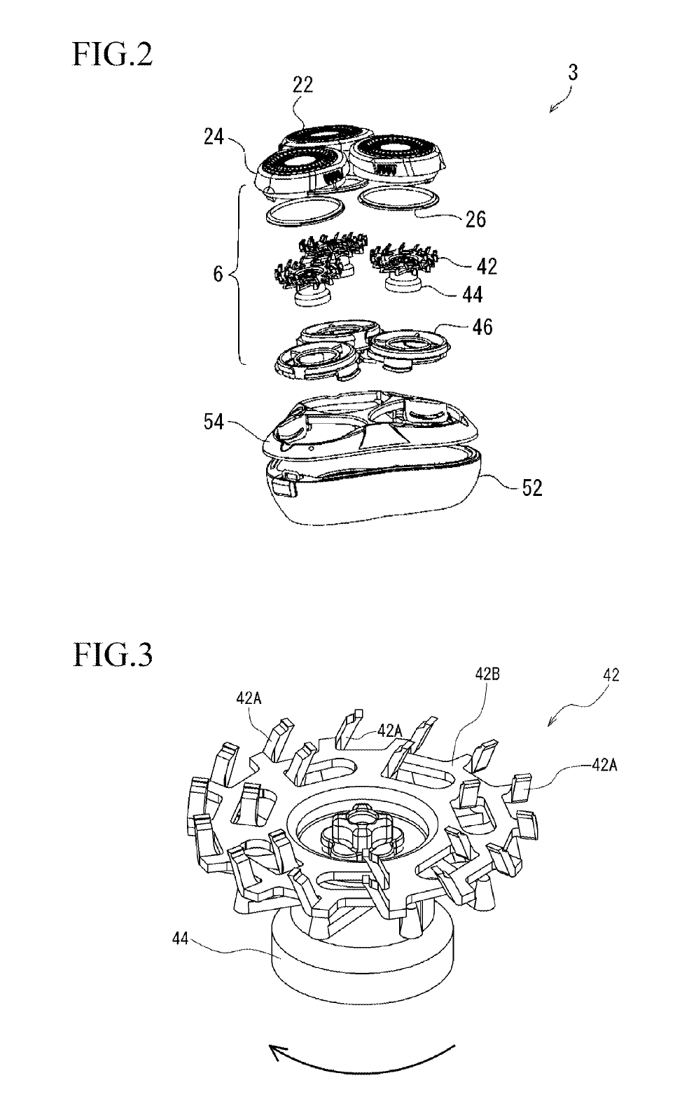

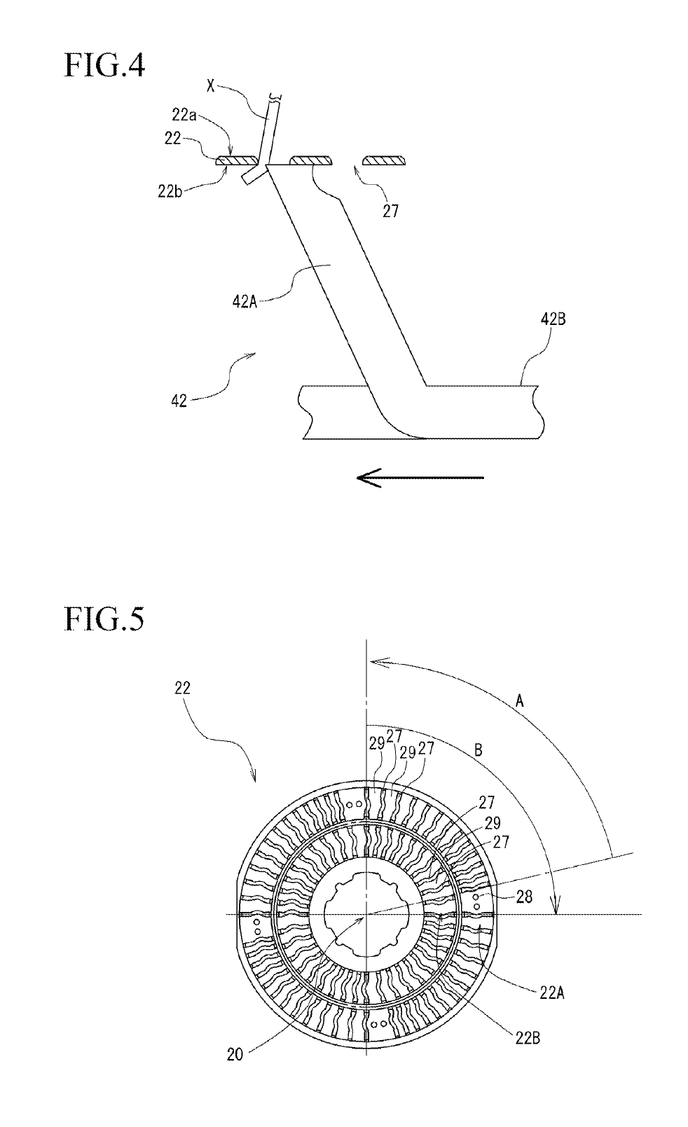

Hereinafter, embodiments of the present invention will be described in detail with reference to the drawings. FIG. 1 is a schematic view (perspective view) illustrating an example of a rotary electric shaver 1 according to the present embodiment. In addition, FIG. 2 is a schematic view (exploded perspective view) illustrating an example of a head unit 3 in the rotary electric shaver 1. In addition, FIG. 3 is a schematic view (perspective view) illustrating an example of an inner blade 42 in the rotary electric shaver 1. FIG. 4 is a schematic view illustrating the inner blade 42 (particularly, small blade 42A) and a portion of an outer blade 22 (cross section). Referring to all drawings used in describing the embodiments, the same reference numerals are given to members having the same function, and repeated description thereof will be omitted in some cases.

As illustrated in FIGS. 1 and 2, the rotary electric shaver 1 according to the present embodiment includes an outer blade 22 having multiple penetrating hair inlets 27 formed therein and an inner blade 42 rotating while coming into sliding contact with a lower surface of the outer blade 22, and cuts hair entering the multiple hair inlets 27 by using the outer blade 22 and the inner blade 42. In the present invention, examples of the hairs include beards, mustache, whisker, and the like. An example will be described in which the rotary electric shaver 1 has three sets of a blade unit 6 including the outer blade 22 and the inner blade 42. However, without being limited thereto, the present invention may employ one set or other multiple sets.

In FIG. 1, the reference numeral 2 is a main body, and includes a substantially cylindrical case 10. A motor for rotatably driving the inner blade 42, a battery for supplying electric power to the motor, and a control unit for controlling the rotary drive (all not illustrated) are accommodated inside the case 10. A switch button 12 for turning on and off a power source is disposed on a front surface of the case 10. A display unit 14 having an LED lamp for indicating battery residual capacity is disposed below the switch button 12.

As illustrated in FIG. 2, the head unit 3 includes a head case 52 which is held by being connected to an upper portion of the case 10 in the main body 2, a blade frame 54 which covers the head case 52 from above, a drive mechanism (not illustrated) which is accommodated in an inner bottom portion of the head case 52, and three sets of blade unit 6 which are held in the blade frame 54 so as to be slightly and vertically movable and swingable. Here, each blade unit 6 includes the outer blade 22 having a substantially disc shape and the inner blade 42 rotating while coming into sliding contact with the lower surface (inner surface) of the outer blade 22. In addition, three sets of blade unit 6 are arranged so as to form a triangle in a plane view. As described above, the present embodiment employs a case example where three sets of blade unit 6 are included therein. However, a basic configuration may be similarly conceivable even in a case where blade units are included in an alternative combination other than three sets.

Here, the outer blade 22 is configured so that multiple holes 27 serving as hair inlets are formed to penetrate in an axial direction (that is, direction which is the same as the axial direction of a rotation axis of the inner blade) and the inner blade 42 cuts the hair entering the hair inlets 27. That is, the outer blade 22 is configured so that an upper surface 22a serves as a hair cutting surface which comes into contact with skin of a user and the hair inlets 27 are open on the upper surface 22a. As an example, the upper surface 22a is formed in an annular plane, that is, as an annular shaving surface. In addition, the outer blade 22 has a shape whose peripheral edge is bent downward and an outer blade ring 24 is fitted into the peripheral edge thereof. A stopper ring 26 is fitted into an inner periphery of the outer blade ring 24, and the outer blade 22 is fixed to the outer blade ring 24.

On the other hand, the inner blade 42 is fixed to an inner blade holder 44, and a recess for fitting an upper end of an inner blade drive shaft (not illustrated) connected to an output shaft of the motor is formed in a lower portion of the inner blade holder 44. The inner blade 42 is held so as to be swingable to the outer blade 22 side by an inner blade rest 46 fitted into the outer blade ring 24, thereby forming three sets of independent blade unit 6.

As illustrated in FIG. 3, the inner blade 42 according to the present embodiment is configured to include multiple small blades 42A in which a metal plate is partially disposed upright from a plate surface 42B (reference numeral is given to only a few of the small blades in order to simplify the illustration). As an example, the inner blade 42 is formed as an integral structure in such a way that a metal plate made of stainless steel is used, and punching and bending are performed thereon by means of pressing work.

The blade unit 6 is assembled so as to include the above-described configuration, thereby bringing the small blade 42A of the inner blade 42 into contact with a lower surface 22b of the outer blade 22 (refer to FIG. 4). In this state, the inner blade 42 is rotatably driven in an arrow direction, thereby enabling a blade edge of the inner blade 42 (small blade 42A) to cut hair X entering the hair inlets 27.

Here, a configuration of the outer blade 22 according to the present embodiment will be described in detail with reference to the drawings.

### First Embodiment

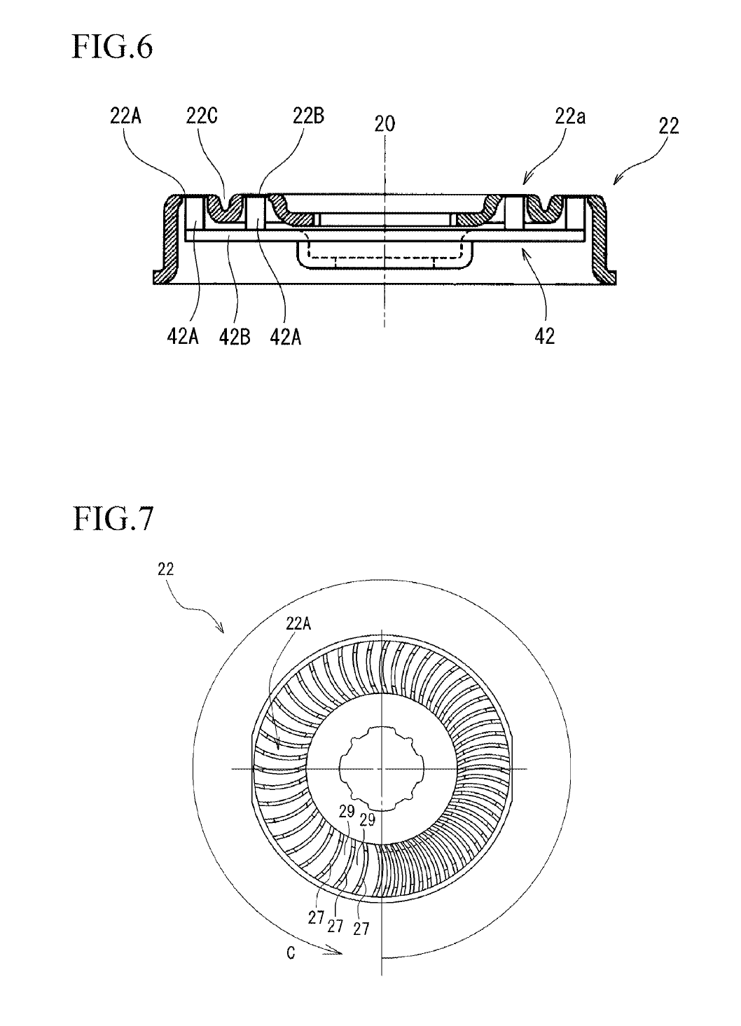

First, FIGS. 5 and 6 illustrate a first embodiment of the outer blade 22. Here, FIG. 5 is a plan view of the outer blade 22, and FIG. 6 is a front sectional view of the outer blade 22.

In the present embodiment, as illustrated in FIGS. 5 and 6, two (double) annular shaving surfaces 22A and 22B serving as the upper surface of the outer blade 22 are formed concentrically with a central axis 20, and an annular recessed groove 22C is formed therebetween (intermediate position in the radial direction). As an example, as illustrated in FIG. 6, the annular shaving surfaces 22A and 22B are configured to have the same height along the central axis 20. However, without being limited to this configuration, the annular shaving surface 22A located on the inner side may be configured to be higher along the central axis 20 than the annular shaving surface 22A located on the outer side.

Here, the outer blade 22 is formed as an integral structure in such a way that a metal plate made of stainless steel is used, and punching and bending are performed thereon by means of pressing work. However, without being limited thereto, various configurations can be employed such as a configuration in which the annular shaving surfaces 22A and 22B are separately formed and fixed to each other, or a configuration in which the annular shaving surfaces 22A and 22B are separately formed and connected to each other so as to be mutually movable in the axial direction. Without being limited to two annular shaving surfaces, a configuration may be adopted which includes one annular shaving surface, or alternatively three or more annular shaving surfaces.

In addition, the annular shaving surfaces 22A and 22B have multiple hair inlets formed thereon. In the present embodiment, the hair inlets include hair inlets 27 having an elongated hole shape in a plan view and hair inlets 28 having a round hole shape in a plan view. Here, the term “round hole shape” is not limited to a perfect circular shape, and is intended to include other circular shapes such as an oval shape or an elliptical shape. A configuration may be adopted in which the multiple hair inlets include only the hair inlets 27 having the elongated hole shape.

In the outer blade 22 according to the present embodiment, the hair inlets are juxtaposed by changing the circumferential distances therebetween (that is, arranged so that the circumferential distances between the adjacent hair inlets are not constant) in a predetermined circumferential area on the annular shaving surfaces 22A and 22B. Here, as an example of the configuration in which the hair inlets are juxtaposed by changing the circumferential distances therebetween, multiple hair inlets (here, hair inlets 27 having the elongated hole shape) disposed on the annular shaving surface 22A in the outer periphery are arranged so that the circumferential distances between the adjacent hair inlets gradually increase in a direction of an arrow A in the circumferential area indicated by the arrow A. In addition, multiple hair inlets (here, hair inlets 27 having the elongated hole shape) disposed on the annular shaving surface 22B in the inner periphery are arranged so that the circumferential distances between the adjacent hair inlets gradually increases in the direction of an arrow B in the circumferential area indicated by the arrow B.

An example of the configuration in which the multiple hair inlets are juxtaposed by changing the circumferential distances in the predetermined circumferential area is not limited to the above-described example. That is, the predetermined circumferential area can be set in various ways such as one circumference, or one circumference divided into equal areas (two equal areas, three equal areas, or the like), or alternatively one circumference divided into unequal areas. In addition, the arrangement for changing the circumferential distances can be set in various ways such as arrangement by gradually increasing or decreasing the distances (changing rate of the increase or the decrease may be continuous, discontinuous, or stepwise), or alternatively, an arrangement provided with multiple equal distances. In addition, without being limited to the arrangement for changing the distances for the unit of each hair inlet, an arrangement may be made by changing the distances for the unit of a group of hair inlets. According to a configuration of forming each hair inlet (alternatively, a group of hair inlets) in the same shape, pressing work is facilitated.

The hair inlet 27 having an elongated hole shape is very effectively used in catching hair. In particular, it is possible to improve performance for catching various types of hair such as long hair, coarse hair, or the like by narrowing the circumferential distance between the adjacent hair inlets as much as possible and by decreasing an area of a “blank portion” (also called a “solid portion”) 29 which is a planar area having no hair inlets. In contrast, as the area of the blank portion further decreases, smooth movement along skin is no longer possible, and a user's skin comes to feel an unfavorable sensation. Consequently, there is a conflicting problem in that the skin is likely to be damaged due to deep shaving even if a pressing force applied to the skin decreases.

However, as in the present embodiment, according to the configuration in which the multiple hair inlets are juxtaposed by changing the circumferential distances in the predetermined circumferential area, it is possible to make an arrangement in which the circumferential distances of the adjacent hair inlets are relatively narrower. Accordingly, it is possible to prevent the hair from remaining unshaved and to improve shaving quality by improving performance for catching various types of hair. At the same time, it is possible to make an arrangement in which the circumferential distances of the adjacent hair inlets are relatively wider. Accordingly, the smooth movement along the skin is possible, and it is possible to provide the more favorable sensation to the skin. It is possible to decrease a possibility that the skin may be damaged due to deep shaving. Therefore, it is possible to solve the above-described conflicting problem.

Here, the hair inlet 27 having an elongated hole shape can employ various shapes, for example, such as a shape whose long side portion is linear, or a shape whose long side portion is entirely or partially curved.

As an example, the hair inlet 27 having an elongated hole shape according to the present embodiment is formed so that the long side portion is partially (here, intermediate portion in the longitudinal direction) curved as illustrated in FIG. 5. As described above, according to a configuration in which the long side portion has a partially (or entirely) curved portion, long hair or coarse hair is particularly likely to be caught on the curved portion, and is likely to be introduced into holes (into the hair inlets). Accordingly, it is possible to achieve further improved performance for catching the hair. In the present embodiment, the outer blade 22 is formed by means of shearing press work. In this manner, it is possible to from the hair inlet having a complicated shape as described above. However, another method for forming the hair inlet may employ etching, ECM, or the like.

As illustrated in FIG. 5, a configuration may be adopted in which the hair inlet 28 having a round hole shape is appropriately juxtaposed on an annular shaving surface (as an example, 22A). According to this configuration, it is possible to increase an area of the blank portion without significantly deteriorating the performance for catching the hair by using the hair inlet 27 having an elongated hole shape. Accordingly, it is possible to provide further improved skin-fitting shaving and favorable sensation to the skin, and thus it is possible to prevent deep shaving.

### Second Embodiment

Next, FIG. 7 illustrates a second embodiment of the outer blade 22. Here, FIG. 7 is a plan view of the outer blade 22.

The outer blade 22 according to the present embodiment is an example of one (single) annular shaving surface. The basic configuration and operation effect thereof are the same as those in the above-described first embodiment, and thus points which are different therefrom will be mainly described.

In the outer blade 22 according to the present embodiment, the hair inlets are juxtaposed by changing the circumferential distances therebetween (that is, arranged so that the circumferential distances between the adjacent hair inlets are not constant) in a predetermined circumferential area on the annular shaving surface 22A. As an example, multiple hair inlets (here, hair inlets 27 having an elongated hole shape) disposed on the annular shaving surface 22A are arranged so that the circumferential distances between the adjacent hair inlets gradually increase in the direction of an arrow C in the circumferential area indicated by the arrow C (here, one circumferential area on the annular shaving surface).

In addition, as illustrated in FIG. 7, the hair inlet 27 having an elongated hole shape according to the present embodiment is formed so that the long side portion is entirely curved. According to this configuration, long hair or coarse hair is also likely to be caught on the curved portion, and is likely to be introduced into holes (into the hair inlets). Accordingly, it is possible to achieve further improved performance for catching the hair.

As described above, the number of annular shaving surfaces, the shape of the hair inlet, setting of a predetermined circumferential area, and an arrangement for changing the circumferential distances are not limited to the above-described embodiments.

The outer blade 22 according to the present embodiment can also provide the same operation effect as the outer blade 22 according to the above-described first embodiment.

### Third Embodiment

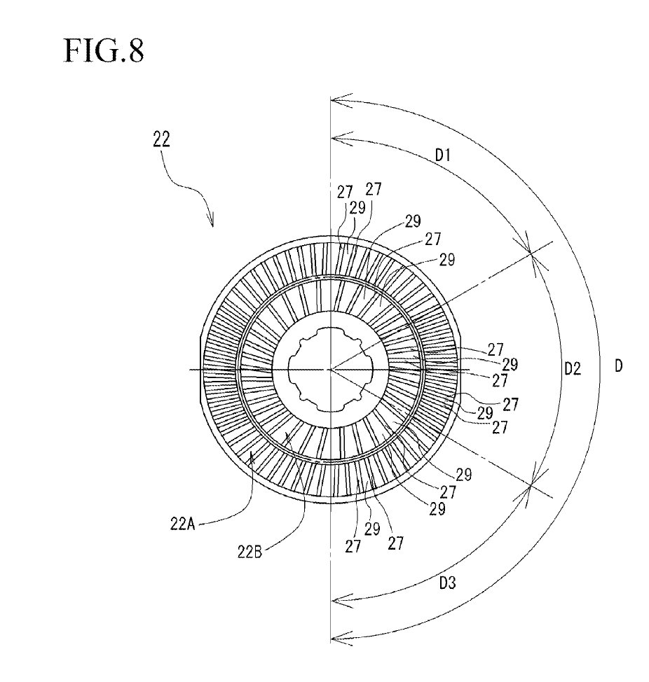

Next, FIG. 8 illustrates a third embodiment of the outer blade 22. FIG. 8 is a plan view of the outer blade 22.

The outer blade 22 according to the present embodiment is an example of two (double) annular shaving surfaces. The basic configuration and operation effect thereof are the same as those in the above-described first embodiment, and thus points which are different therefrom will be mainly described.

In the outer blade 22 according to the present embodiment, the hair inlets are juxtaposed by changing circumferential distances therebetween (that is, arranged so that the circumferential distances between the adjacent hair inlets are not constant) in a predetermined circumferential area on the annular shaving surfaces 22A and 22B. As an example, multiple hair inlets (here, hair inlets 27 having an elongated hole shape) disposed on the annular shaving surface 22A in the outer periphery are arranged by changing the circumferential distances so that the circumferential distance between the adjacent hair inlets in areas D1 and D3 is relatively wider, and the circumferential distance between the adjacent hair inlets in an area D2 is narrower, in a circumferential area indicated by an arrow D (here, half of the area of the annular shaving surface). In addition, multiple hair inlets (here, hair inlets 27 having an elongated hole shape) disposed on the annular shaving surface 22B in the inner periphery are arranged by changing the circumferential distances so that the circumferential distance between the adjacent hair inlets in the areas D1 and D3 is relatively wider, and the circumferential distance between the adjacent hair inlets in the area D2 is relatively narrower, in the circumferential area indicated by the arrow D (here, half of the area on the annular shaving surface). In the present embodiment, the areas D1 to D3 are set in the same angular range on the annular shaving surface 22A in the outer periphery and the annular shaving surface 22B in the inner periphery. However, without being limited thereto, the areas D1 to D3 may be set in angular ranges which are different from each other.

As described above, the number of annular shaving surfaces, the shape of the hair inlet, setting of a predetermined circumferential area, and an arrangement for changing the circumferential distances are not limited to the above-described embodiments.

The outer blade 22 according to the present embodiment can also provide the same operation effect as the outer blade 22 according to the above-described first embodiment.

### Fourth Embodiment

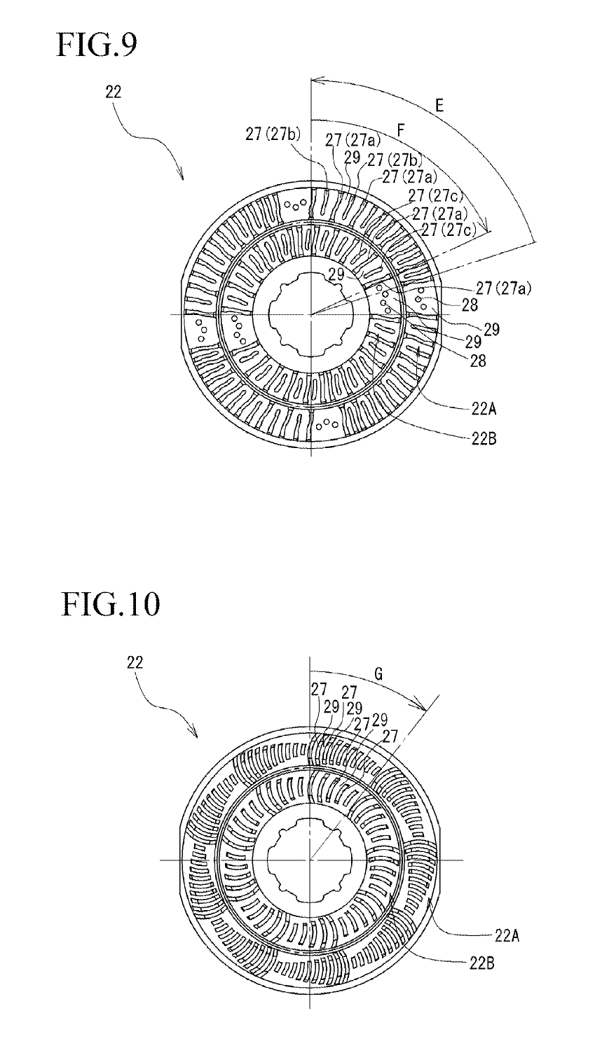

Next, FIG. 9 illustrates a fourth embodiment of the outer blade 22. FIG. 9 is a plan view of the outer blade 22.

The outer blade 22 according to the present embodiment is an example of two (double) annular shaving surfaces. The basic configuration and operation effect thereof are the same as those in the above-described first embodiment, and thus points which are different therefrom will be mainly described.

In the outer blade 22 according to the present embodiment, the hair inlets are juxtaposed by changing circumferential distances therebetween (that is, arranged so that the circumferential distances between the adjacent hair inlets are not constant) in a predetermined circumferential area on the annular shaving surfaces 22A and 22B. This configuration is the same as that of the above-described first embodiment.

Therefore, the outer blade 22 according to the present embodiment can also provide the same operation effect as the outer blade 22 according to the above-described first embodiment.

In addition to this configuration, according to a characteristic configuration according to the present embodiment, multiple hair inlets (here, hair inlets 27 having an elongated hole shape) disposed on the annular shaving surface 22A in the outer periphery are arranged so that a hair inlet 27a having a shape which is open and reaches both ends in the radial direction of the annular shaving surface 22A and a hair inlet 27b having a shape in which opening does not reach both ends in the radial direction of the annular shaving surface 22A (as an example, a shape whose opening reaches one end on the outer side and does not reach the other end on the inner side) are alternately arranged in the circumferential direction in a circumferential area indicated by an arrow E. In addition, multiple hair inlets (here, hair inlets 27 having an elongated hole shape) disposed on the annular shaving surface 22B in the inner periphery are arranged so that the hair inlet 27a having a shape which is open and reaches both ends in the radial direction of the annular shaving surface 22B and a hair inlet 27c having a shape in which opening does not reach both ends in the radial direction of the annular shaving surface 22A (as an example, a shape whose opening does not reach both of one end on the outer side and the other end on the inner side) are alternately arranged in the circumferential direction in a circumferential area indicated by an arrow F.

According to this configuration, the outer blade 22 particularly has the hair inlet 27b (or 27c) in which opening does not reach both ends. Accordingly, it is possible to increase the area of the blank portion 29. Therefore, it is possible to provide further improved skin-fitting shaving and favorable sensation to the skin, and thus it is possible to prevent deep shaving. In this case, even if the hair inlet 27a having a shape which is open and reaches both ends and the hair inlet 27b (or 27c) having a shape in which opening does not reach both ends are alternately arranged in the circumferential direction, there is no possibility of significantly deteriorating performance for capturing coarse hair.

As described above, the number of annular shaving surfaces, the shape of the hair inlet, setting of a predetermined circumferential area, and an arrangement for changing the circumferential distances are not limited to the above-described embodiments.

### Fifth Embodiment

Next, FIG. 10 illustrates a fifth embodiment of the outer blade 22. FIG. 10 is a plan view of the outer blade 22.

The outer blade 22 according to the present embodiment is an example of two (double) annular shaving surfaces. The basic configuration and operation effect thereof are the same as those in the above-described first embodiment, and thus points which are different therefrom will be mainly described.

In the outer blade 22 according to the present embodiment, hair inlets are juxtaposed so that circumferential distances are constant (that is, the circumferential distance between the adjacent hair inlets is constant) and opening density is changed (that is, so that an opening area (density) per unit area is changed) in a predetermined circumferential area on the annular shaving surfaces 22A and 22B. Here, as an example of a configuration in which the hair inlets are juxtaposed so that the circumferential distances are constant and the opening density is changed, multiple hair inlets (here, the hair inlets 27 having an elongated hole shape) disposed on the annular shaving surface 22A in the outer periphery are arranged so that the circumferential distance between the adjacent hair inlets is constant and the opening density gradually decreases in the direction of the arrow G in a circumferential area (here, one ninth of an area on the annular shaving surface) indicated by an arrow G. In addition, multiple hair inlets (here, the hair inlets 27 having an elongated hole shape) disposed on the annular shaving surface 22B in the inner periphery are arranged so that the circumferential distance between the adjacent hair inlets is constant and the opening density gradually decreases in the direction of the arrow G in the circumferential area indicated by an arrow G.

According to this configuration, the hair inlets are juxtaposed so that the opening density is relatively high. In this manner, it is possible to prevent the hair from remaining unshaved and to improve shaving quality by improving performance for catching various types of hair. At the same time, the hair inlets juxtaposed so that the opening density which is relatively low enables smooth movement along the skin, and it is possible to provide further improved favorable sensation to the skin. It is possible to decrease a possibility that the skin may be damaged due to deep shaving.

Here, the hair inlet 27 having an elongated hole shape can employ various shapes, for example, such as a shape whose long side portion is linear or a shape whose long side portion is entirely or partially curved. In addition, a configuration may be adopted in which the hair inlet 28 having a round hole shape is appropriately juxtaposed therein.

As described above, the number of annular shaving surfaces, the shape of the hair inlet, setting of a predetermined circumferential area, and a changing rate in opening density are not limited to the above-described embodiments.

As described above, according to the rotary electric shaver in the present invention, the outer blade can smoothly move along skin, it is possible to reliably catch any type of hair, and it is possible to prevent the skin from being damaged due to deep shaving. In this manner, it is possible to solve the conflicting problem.

Without being limited to the above-described embodiments, the present invention can be modified in various ways within the scope not departing from the spirit of the present invention. In particular, the number of combinations (blade units) between the outer blade and the inner blade, the number of annular shaving surfaces, the shape of the hair inlets, setting of a predetermined circumferential area, and an arrangement for changing the circumferential distances are not limited to the above-described embodiments.

1. A rotary electric shaver comprising:
an outer blade whose upper surface functions as annular shaving surfaces having multiple hair inlets formed therein; and
an inner blade that has a small blade which rotates while coming into sliding contact with a lower surface of the outer blade from below the annular shaving surfaces,
wherein the outer blade is configured so that the hair inlets are juxtaposed by changing a circumferential distance in a predetermined circumferential area on the annular shaving surfaces.

2. A rotary electric shaver comprising:
an outer blade whose upper surface functions as annular shaving surfaces having multiple hair inlets formed therein; and
an inner blade that has a small blade which rotates while coming into sliding contact with a lower surface of the outer blade from below the annular shaving surfaces,
wherein the outer blade is configured so that the hair inlets are juxtaposed so that circumferential distances are constant and opening density is changed in a predetermined circumferential area on the annular shaving surfaces.

3. The rotary electric shaver according to claim 1,
wherein at least a portion of the multiple hair inlets is formed in an elongated hole shape.

4. The rotary electric shaver according to claim 2,
wherein at least a portion of the multiple hair inlets is formed in an elongated hole shape.

5. The rotary electric shaver according to claim 3,
wherein the hair inlet having the elongated hole shape is formed in a shape whose long side portion is linear or a shape whose long side portion is entirely or partially curved.

6. The rotary electric shaver according to claim 4,
wherein the hair inlet having the elongated hole shape is formed in a shape whose long side portion is linear or a shape whose long side portion is entirely or partially curved.

7. The rotary electric shaver according to claim 1,
wherein the outer blade is configured so that the hair inlet which is open and reaches both ends in the radial direction on the annular shaving surfaces and the hair inlet in which opening does not reach both ends are alternately arranged in the circumferential direction in the predetermined circumferential area on the annular shaving surfaces.

8. The rotary electric shaver according to claim 2,
wherein the outer blade is configured so that the hair inlet which is open and reaches both ends in the radial direction on the annular shaving surfaces and the hair inlet in which opening does not reach both ends are alternately arranged in the circumferential direction in the predetermined circumferential area on the annular shaving surfaces.

9. The rotary electric shaver according to claim 3,
wherein the outer blade is configured so that the hair inlet which is open and reaches both ends in the radial direction on the annular shaving surfaces and the hair inlet in which opening does not reach both ends are alternately arranged in the circumferential direction in the predetermined circumferential area on the annular shaving surfaces.

10. The rotary electric shaver according to claim 4,
wherein the outer blade is configured so that the hair inlet which is open and reaches both ends in the radial direction on the annular shaving surfaces and the hair inlet in which opening does not reach both ends are alternately arranged in the circumferential direction in the predetermined circumferential area on the annular shaving surfaces.

11. The rotary electric shaver according to claim 5,
wherein the outer blade is configured so that the hair inlet which is open and reaches both ends in the radial direction on the annular shaving surfaces and the hair inlet in which opening does not reach both ends are alternately arranged in the circumferential direction in the predetermined circumferential area on the annular shaving surfaces.

12. The rotary electric shaver according to claim 6,
wherein the outer blade is configured so that the hair inlet which is open and reaches both ends in the radial direction on the annular shaving surfaces and the hair inlet in which opening does not reach both ends are alternately arranged in the circumferential direction in the predetermined circumferential area on the annular shaving surfaces.
